(19) United States
(12) Patent Application Publication
(10) Pub. No.: US 2026/0119096 A1
(43) Pub. Date: Apr. 30, 2026

(54) NON-TRANSITORY COMPUTER-READABLE RECORDING MEDIUM STORING SUPPORT APPLICATION PROGRAM FOR TERMINAL DEVICE, AND METHOD FOR CONTROLLING TERMINAL DEVICE ACCORDING TO SUPPORT APPLICATION PROGRAM

(71) Applicant: BROTHER KOGYO KABUSHIKI KAISHA, Nagoya (JP)

(72) Inventor: Airi EGUCHI, Ichinomiya (JP)

(21) Appl. No.: 19/371,466

(22) Filed: Oct. 28, 2025

(30) Foreign Application Priority Data
Oct. 31, 2024 (JP) 2024-191748

(51) Int. Cl. G06F 3/12

(52) U.S. Cl. CPC G06F 3/1239; G06F 3/1203; G06F 3/1228; G06F 3/1286; G06F 3/1287

(57) ABSTRACT

A terminal device may, according to a support application program, in a case where a first instruction corresponding to a printing-related operation related to printing is acquired from the OS program and an end user license agreement related to the computer program has not been agreed, display, on a display of the terminal device, an end user license agreement screen. In a case where the first instruction is acquired from the OS program and the end user license agreement has been agreed, the end user license agreement screen may not be displayed. In a case where an operation of not agreeing to the end user license agreement is received on the end user license agreement screen displayed in response to the first instruction being acquired from the OS program, execution of a process corresponding to the printing-related operation may be limited.

### REFERENCE TO RELATED APPLICATION

This application claims priority to Japanese Patent Application No. 2024-191748 filed on Oct. 31, 2024. The entire content of the priority application is incorporated herein by reference.

### BACKGROUND ART

A system including a client computer, a printer, a device management software distribution server, and a device application distribution server is known. In the client computer, an application, a device application, and a printer driver are stored.

### SUMMARY

The present teachings provide a novel and useful art configured to suitably display an end-user license agreement screen.

The disclosure discloses a non-transitory computer-readable recording medium storing a support application program for a terminal device. The support application program may be a program for supporting a generic printing program implemented in an operating system (OS) program of the terminal device. The support application program, when executed by a processor of the terminal device, may cause the terminal device to: in a case where a first instruction corresponding to a printing-related operation related to printing is acquired from the OS program and an end user license agreement related to the support application program has not been agreed, display, on a display of the terminal device, an end user license agreement screen for receiving a selection operation of selecting whether to agree to the end user license agreement. In a case where the first instruction is acquired from the OS program and the end user license agreement has been agreed, the end user license agreement screen may not be displayed. In a case where an operation of not agreeing to the end user license agreement is received on the end user license agreement screen displayed in response to the first instruction being acquired from the OS program, execution of a process corresponding to the printing-related operation may be limited.

According to the above configuration, the terminal device displays the end user license agreement screen on the display according to the support application program in the case where the first instruction is acquired from the OS and also the end user license agreement has not been agreed. Contrary to this, the end user license agreement screen is not displayed when the first instruction is acquired from the OS and also the end user license agreement has been agreed. Accordingly, an end user license screen can be suitably displayed.

In addition, the disclosure discloses another non-transitory computer-readable recording medium storing a support application program for a terminal device. The support application program may be a program for supporting a generic printing program implemented in an operating system (OS) program of the terminal device. The support application program, when executed by a processor of the terminal device, may cause the terminal device to: in a case where a first instruction corresponding to a first predetermined operation is acquired from the OS program and an end user license agreement related to the support application program has not been agreed, display, on a display of the terminal device, an end user license agreement screen for receiving a selection operation of selecting whether to agree to the end user license agreement. In a case where the first instruction is acquired from the OS program and the end user license agreement has been agreed, the end user license agreement screen may not be displayed. The computer program, when executed by the processor, may cause the terminal device to: in a case where a second instruction corresponding to a second predetermined operation different from the first predetermined operation is acquired from the OS program and the end user license agreement has not been agreed, display, on the display, the end user license agreement screen. In a case where the second instruction is acquired from the OS program and the end user license agreement has been agreed, the end user license agreement screen may not be displayed. In a case where an operation of not agreeing to the end user license agreement is received on the end user license agreement screen displayed after the first instruction has been acquired from the OS program, execution of a process corresponding to the first predetermined operation may be limited. In a case where an operation of not agreeing to the end user license agreement is received on the end user license agreement screen displayed after the second instruction has been acquired from the OS program, execution of a process corresponding to the second predetermined operation may be limited.

According to the above configuration, the terminal device displays the end user license agreement screen on the display according to the support application program when the first instruction or the second instruction is acquired from the OS and also the end user license agreement has not been agreed. Contrary to this, the end user license agreement screen is not displayed when the first instruction or the second instruction is acquired from the OS and also the end user license agreement has been agreed. Accordingly, an end user license screen can be suitably displayed.

A non-transitory computer-readable recording medium storing the above-described support application program, a terminal device realized by the above-described support application program, and a method for controlling the terminal device are also novel and useful. Here, the above-mentioned recording medium may be one medium or plural media.

### BRIEF DESCRIPTION OF DRAWINGS

FIG. 1 illustrates a configuration of a communication system.

FIG. 2 illustrates a flowchart of an image display process executed by a PSA.

FIG. 3 illustrates a sequence diagram of Case A in which a print app is activated.

FIG. 4 illustrates a sequence diagram of Case B in which a print operation is performed and Case C in which a print setting operation is performed.

FIG. 5 illustrates an example for a preview screen.

FIG. 6 illustrates an example for a print setting screen.

FIG. 7 illustrates a sequence diagram of Case D in which a EULA is not agreed.

FIG. 8 illustrates a sequence diagram of Case E and Case F in which a print operation is performed.

FIG. 9 illustrates a sequence diagram of Case G in which a EULA screen is not displayed.

FIG. 10 illustrates a sequence diagram of Case H and Case I in which a print operation is performed.

FIG. 11 illustrates an example for a device setting screen.

### DESCRIPTION

### Embodiment

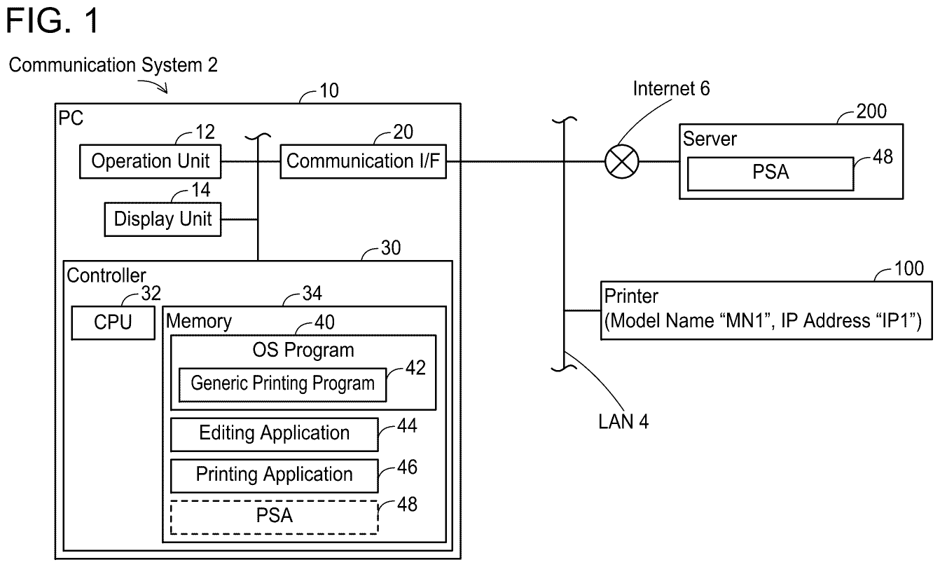

### (Configuration of Communication System 2; FIG. 1)

As illustrated in FIG. 1, a communication system 2 comprises a Personal Computer (PC) 10, a printer 100, and a server 200. The PC 10 and the printer 100 are connected to a Local Area Network (LAN) 4. The PC 10 and the printer 100 are configured to communicate with each other via the LAN 4. The LAN 4 is connected to the Internet 6. The server 200 is disposed on the Internet 6. The PC 10, the printer 100, and the server 200 are configured to communicate with each other through the Internet 6. Hereafter, an application, which is abbreviation for an application program, may be referred to as “app”.

### (Configuration of PC 10)

The PC 10 is a PC such as a desktop PC, a laptop PC, a tablet PC. The PC 10 comprises an operation unit 12, a display unit 14, a communication interface 20, and a controller 30. Hereafter, interface will be referred to as “I/F”.

The operation unit 12 is a user interface which allows a user to input various information to the PC 10. The operation unit 12 comprises a touch panel for displaying software key(s) (operation area), hardware key(s), or both of them. The hardware key(s) include for example button(s) and/or switch(es). The display unit 14 is a display or a panel for displaying various information. The display may be a liquid crystal display or an organic EL display, for example. The panel may be a touch panel or may not be a touch panel. Also, the panel is for example a liquid crystal panel or an organic EL panel. The communication I/F 20 is connected to the LAN 4. The communication I/F 20 may be a wired LAN I/F or may be a wireless LAN I/F. Also, the communication I/F 20 may be a USB I/F.

The controller 30 comprises a CPU 32 and a memory 34. The memory 34 comprises a primary storage and an auxiliary storage. Although this is an example, the primary storage includes a RAM and cache memory. Although this is an example, the auxiliary storage may be a ROM, flash memory, Solid State Drive (SSD), Hard Disk Drive (HDD), or a combination thereof. The CPU 32 realizes various processes in accordance with a program loaded from the auxiliary storage onto the primary storage.

In the auxiliary storage of the memory 34, an Operating System (OS) program 40, an editing app 44, and a print app 46 are stored. Hereafter, the OS program 40 will be referred to as “OS 40”. Although this is an example, the OS 40 is Windows. Windows is a registered trademark of Microsoft Corporation. Microsoft is a registered trademark of Microsoft Corporation.

The OS 40 comprises a generic printing program 42. Although this is an example, the generic printing program 42 is IPP Class Driver. Also, the generic printing program 42 can be regarded as a printer driver with which the OS 40 is provided by default, and may be of another type other than IPP Class Driver. The generic printing program 42 has a general function of allowing multiple types of printers provided by multiple printer vendors to execute printing. The generic printing program 42 is different from a dedicated printer driver that is unique to each printer and thus does not support functions each printer uniquely has. The generic printing program 42 has a function of generating intermediate image data when a print instruction and image data to be printed are acquired. Although this is an example, the intermediate image data is XPS data. The generic printing program 42 further has a function of converting the intermediate image data into print data of a format by which the multiple types of printers are able to execute printing. Although this is an example, the print data is PWG Raster data, PDF.

The editing app 44 is a program for editing and/or creating a document. Although this is an example, the editing app 44 is Word, Excel of Microsoft Corporation. The print app 46 is a program for allowing a printer to execute a print function. The print app 46 is provided by a vendor of the printer 100.

The auxiliary storage of the memory 34 may have a Print Support Application (PSA) 48 stored therein. The PSA 48 is a program configured to support the generic printing program 42. Here, “support the generic printing program 42” may be regarded as supporting processes according to the generic printing program 42. The PSA may be compatible with one model provided by a certain printer vendor, or may be compatible with multiple models provided by the same printer vendor. The PSA 48 is a program compatible with printer(s) having the model name “MN1”. The PSA 48 is provided by the vendor of the printer 100. The PSA 48 is configured to be automatically downloaded onto the PC 10 from the server 200 when a printer compatible with the PSA 48 (e.g., the printer 100) is connected to the PC 10. Here, the OS 40 may detect that the printer has been connected to the PC 10 through a USB I/F by using Plug and Play (PnP). Also, the OS 40 may detect that the printer has been connected to the PC 10 through a wired LAN I/F or wireless LAN I/F.

### (Configuration of Printer 100)

The printer 100 is a peripheral device configured to execute the print function of printing an image on a document (that is, a peripheral device for the PC 10 for example). The printer 100 comprises a print mechanism configured to execute the print function. The print mechanism includes an inkjet print engine, an electronic photo print engine, or a thermal print engine. The inkjet print engine comprises a print head which ejects ink droplets. The electronic photo print engine comprises a photoreceptor and an exposure device which emits light to expose the photoreceptor. The thermal print engine comprises a print head which ejects heat with a heater.

The printer 100 has a model name “MN1”. The printer 100 is assigned an IP address “IP1”.

### (Configuration of Server 200)

The server 200 is a server disposed on the Internet 6 by a vendor of the OS 40. Although this is an example, the server 200 is a cloud server which provides service(s) of Microsoft Store. The server 200 may be a single server, or may be a collection of plural servers.

In the server 200, various programs compatible with the OS 40 are stored. In the present embodiment, the server 200 has the PSA 48 stored therein.

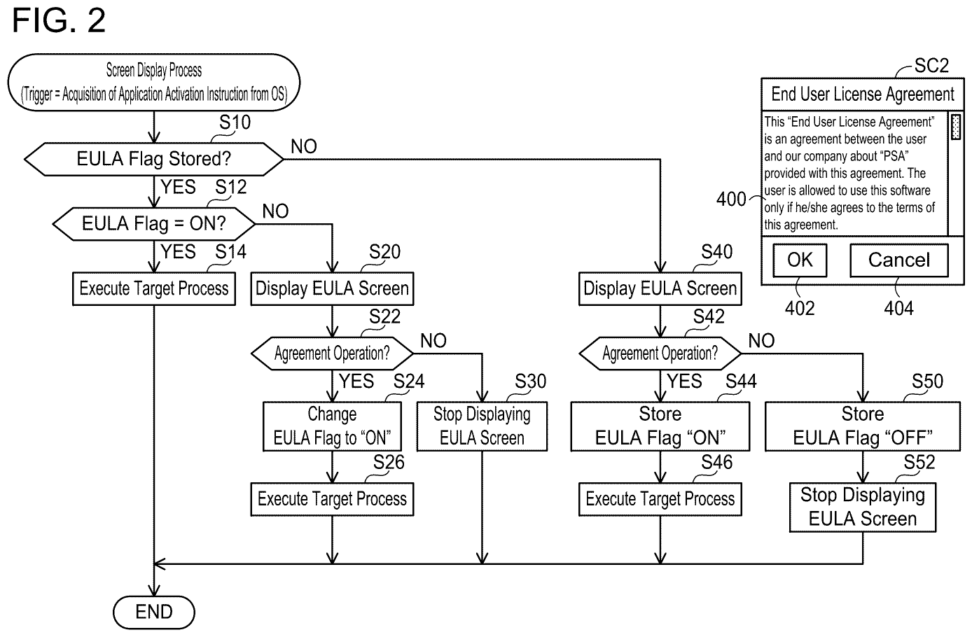

### (Screen Display Process; FIG. 2)

With reference to FIG. 2, a screen display process executed by the PSA 48 with the PSA 48 installed on the PC 10 will be described. When the PSA 48 acquires an application activation instruction from the OS 40, the PSA 48 executes processes of FIG. 2. Specifically, when a first application activation instruction, a second application activation instruction, or a third application activation instruction to be described later is acquired from the OS 40, the PSA 48 executes the processes of FIG. 2. Hereafter, respective processes executed by the CPU 32 in accordance with a program may be described as if each program (e.g., the OS 40, the PSA 48) executes the respective processes as its subject of action. Further, the PSA 48 for example executes the respective process by accessing each hardware such as the display unit 14, the memory 34, the communication I/F 20 through the OS 40. Hereafter, description may be made without mentioning that the PSA 48 for example executes a process through the OS 40.

Here, in the present teachings, “acquire information” is used in a concept which does not necessarily require “request the information”. That is, “acquire information” is a concept which also encompasses “passively receive information”.

Also, “supply specific information to a certain program” can be said as distributing the specific information to a process of the certain program. An example where a memory is shared will be described. “Supply information to a certain program” refers to storing specific identification information which identifies the specific information in a storage area in the shared memory which computer(s) executing a process according to the certain program can access. Also, “acquire information from a certain program” refers to acquiring the specific information based on the above-mentioned storage area and the specific identification information. Here, a method of supplying/acquiring information between a plurality of programs may comprise a method of using a socket communication and/or a method using pipe communication.

In S10, the PSA 48 determines whether a EULA flag is stored in the memory 34 or not. EULA is abbreviation of End User License Agreement. EULA is an agreement contracted between a user who uses the PSA 48 and a printer vendor who provides the PSA 48. The EULA flag indicates either “ON” indicating that a user has agreed on EULA regarding the PSA 48 or “OFF” indicating that the user has not agreed on the EULA regarding the PSA 48. The EULA flag is a flag generated by the PSA 48. When the PSA 48 displays a EULA screen SC2 to be described later for the first time, the PSA 48 generates the EULA flag, and stores the generated EULA flag in the memory 34. Specifically, the PSA 48 stores the EULA flag in a first predetermined region. When the EULA flag is stored in the first predetermined region (YES to S10), the PSA 48 proceeds to S12. Contrary to this, when the EULA flag is not stored in the first predetermined region (NO to S10), the PSA 48 proceeds to S40.

In S12, the PSA 48 determines whether the EULA flag in the first predetermined region is “ON” or not. That is, the PSA 48 determines whether the EULA has been agreed. When the EULA flag is “ON” (YES to S12), the PSA 48 proceeds to S14. Contrary to this, when the EULA flag is “OFF” (NO to S12), the PSA 48 proceeds to S20.

In S14, the PSA 48 executes a target process corresponding to the received application activation instruction. When S14 ends, the PSA 48 ends the processes of FIG. 2.

Also, in S20, the PSA 48 displays the EULA screen SC2 on the display unit 14. The EULA screen SC2 includes a contract content region 400, an “OK” button 402, and a “Cancel” button 404. In the contract content region 400, contents related to an agreement contracted between a user who uses the PSA 48 and a printer vendor who provides the PSA 48 is displayed.

In S22, the PSA 48 determines whether an agreement operation which is an operation to agree to the EULA has been received or not. The agreement operation is an operation on the “OK” button 402 on the EULA screen SC2. When the PSA 48 receives the agreement operation (YES to S22), the PSA 48 proceeds to S24. Contrary to this, when the PSA 48 does not receive the agreement operation (NO to S22), the PSA 48 proceeds to S30. Here, when the PSA 48 does not receive the agreement operation is when an operation on the “Cancel” button 404 on the EULA screen SC2 is received. Hereafter, the operation on the “Cancel” button 404 on the EULA screen SC2 may be referred to as “non-agreement operation”.

In S24, the PSA 48 changes the EULA flag in the first predetermined region from “OFF” to “ON”. S26 is the same as S14. When S26 ends, the PSA 48 ends the processes of FIG. 2.

In S30, the PSA 48 stops displaying the EULA screen SC2 without executing the target process. That is, when NO is determined to S22, execution of the target process is limited. When S30 ends, the PSA 48 ends the processes of FIG. 2.

When NO is determined to S10, the PSA 48 displays the EULA screen SC2 on the display unit 14 in S40.

In S42, the PSA 48 determines whether the PSA 48 has received the agreement operation or not. When the PSA 48 receives the agreement operation (YES to S42), the PSA 48 proceeds to S44. Contrary to this, when the PSA 48 does not receive the agreement operation (NO to S42), the PSA 48 proceeds to S50.

In S44, the PSA 48 generates the EULA flag “ON”, and stores the generated EULA flag “ON” in the first predetermined region. The process contents of S46 are the same as those of S14. When S46 ends, the PSA 48 ends the processes of FIG. 2.

In S50, the PSA 48 generates the EULA flag “OFF”, and stores the generated EULA flag “OFF” in the first predetermined region. The process contents of S52 are the same as those of S30. That is, when NO is determined to S42, execution of the target process is limited. When S52 ends, the PSA 48 ends the processes of FIG. 2.

### (Specific Cases)

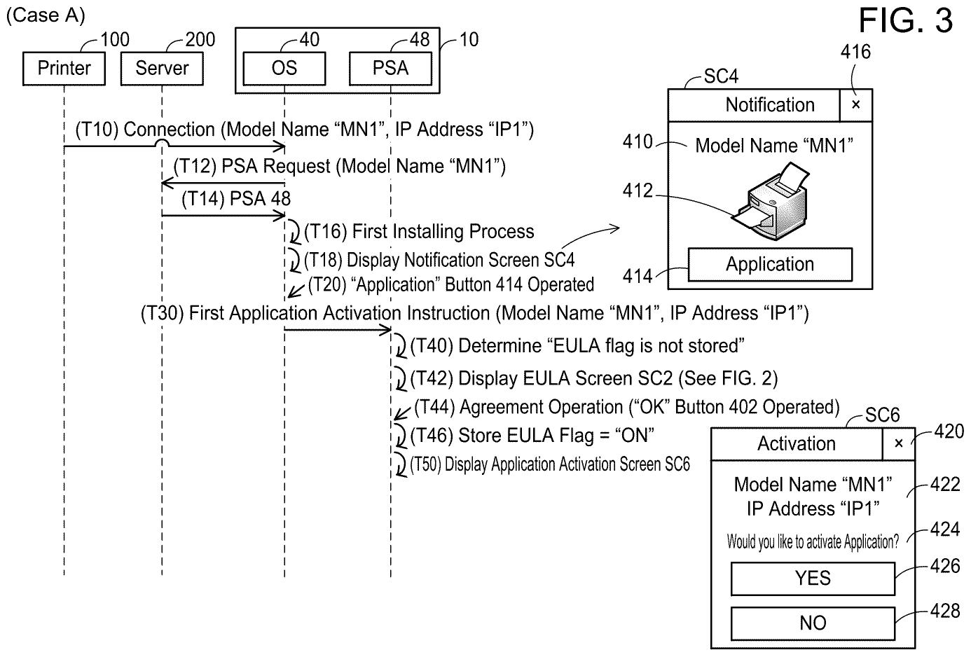

With reference to FIGS. 3 to 10, specific cases realized by the communication system 2 of the present embodiment will be described.

### (Case A; FIG. 3)

With reference to FIG. 3, Case A will be described. In Case A, after the PSA 48 has been installed on the PC 10, an application activation screen SC6 is displayed on the display unit 14. At an initial state of Case A, the PSA 48 is not stored in the memory 34 of the PC 10. Also, the printer 100 is not connected to the LAN 4. That is, the printer 100 is not connected to the PC 10. Due to this, the EULA flag is not stored in the first predetermined region. Hereafter, all communications executed between the PC 10 and another device will be executed through the communication I/F 20 of the PC 10. Due to this, hereafter, the description “through the communication I/F 20” may be omitted.

Firstly, the printer 100 is connected to the LAN 4. Due to this, the OS 40 receives the model name “MN1” and the IP address “IP1” from the printer 100 in T10. In this case, the OS 40 determines that the model name “MN1” and the IP address “IP1” have been received for the first time, and sends a PSA request including the model name “MN1” to the server 200 in T12. The PSA request is a signal for requesting the server 200 to send a PSA corresponding to the model name within such request.

When the server 200 receives the PSA request from the PC 10 in T12, the server 200 specifies the PSA 48 corresponding to the model name “MN1” in the same request. The server 200 sends the specified PSA 48 to the PC 10 in T14. As such, the model name “MN1” in the PSA request can be regarded as identification information for identifying the PSA 48. Here, in a modification, the PSA request may include identification information besides a model name as identification information for identifying the PSA. In the present modification, the server 200 specifies the PSA to be sent to the PC by using this identification information. Although this is an example, the identification information is a hardware ID (HWID) and/or a program ID.

When the OS 40 receives the PSA 48 from the server 200 in T14, the OS 40 executes a first installing process of installing the PSA 48 on the PC 10 in T16. Due to this, the PSA 48 is installed on the PC 10. Subsequently, the OS 40 displays a notification screen SC4 on the display unit 14 by a pop-up in T18. The notification screen SC4 is a screen indicating that the installing of the PSA 48 has been completed. The notification screen SC4 includes a model name region 410 including the model name “MN1” of the printer 100, a printer image 412, an “Application” button 414, and a “Close” button 416. The “Application” button 414 is a button for activating the PSA 48.

In T20, the user performs an operation on the “Application” button 414. Due to this, the OS 40 provides a first application activation instruction including the model name “MN1” and the IP address “IP1” that were received in T10 to the PSA 48 in T30.

The PSA 48 is activated in response to acquiring the first application activation instruction from the OS 40 in T30. As mentioned above, the EULA flag is not stored in the first predetermined region. Due to this, the PSA 48 determines that the EULA flag is not stored in the first predetermined region in T40 (NO to S10 of FIG. 2), and displays the EULA screen SC2 (see FIG. 2) on the display unit 14 in T42 (S40). The user performs the agreement operation in T44 (YES to S42). Due to this, the PSA 48 generates the EULA flag “ON”, and stores the generated EULA flag “ON” in the first predetermined region in T46 (S44). Subsequently, the PSA 48 determines that the print app 46 is activated (running) in the PC 10, and in T50, the PSA 48 executes a print application activation screen display process. Specifically, the PSA 48 displays the application activation screen SC6 on the display unit 14. The print application activation screen display process is an example for the target process of FIG. 2. The application activation screen SC6 includes a “Close” button 420, a device information region 422, a message 424, a “YES” button 426, and a “NO” button 428. The device information region 422 includes the model name “MN1” and the IP address “IP1” that are included in the first application activation instruction (see T30). The message 424 is a message for confirming whether to activate the print app 46 or not. When the PSA 48 receives an operation on the “YES” button 426, the PSA 48 activates the print app 46. Contrary to this, when the PSA 48 receives an operation on the “NO” button 428, the PSA 48 stops displaying the application activation screen SC6 without activating the print app 46. In a modification, in T50, the PSA 48 may display a screen including the model name “MN1”, the IP address “IP1”, and a message “PSA is available now” on the display unit 14, instead of the application activation screen SC6.

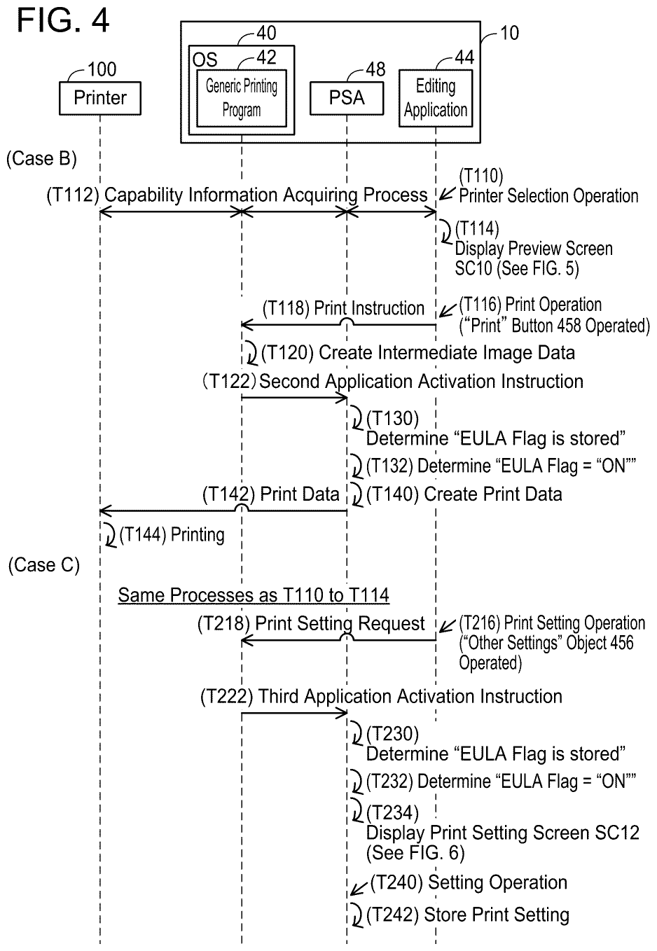

### (Case B; FIG. 4)

With reference to FIG. 4, Case B will be described. In Case B, printing using the editing app 44 is executed. An initial state of Case B is a state after Case A of FIG. 3. That is, the PSA 48 has been installed on the PC 10, and also the EULA flag “ON” is stored in the first predetermined region.

In T110, the user performs a printer selection operation of selecting the printer 100 on the PC 10. Due to this, in T112, a capability information acquiring process is executed between the editing app 44, the PSA 48, the generic printing program 42 of the OS 40, and the printer 100. In the capability information acquiring process, the PSA 48 acquires selection information indicating that the printer 100 has been selected from the editing app 44 via the generic printing program 42. Subsequently, the PSA 48 sends a capability information request to the printer 100 via the generic printing program 42, and receives the capability information from the printer 100 via the generic printing program 42. Next, the PSA 48 stores the received capability information in a second predetermined region, and supplies the capability information to the editing app 44 via the generic printing program 42.

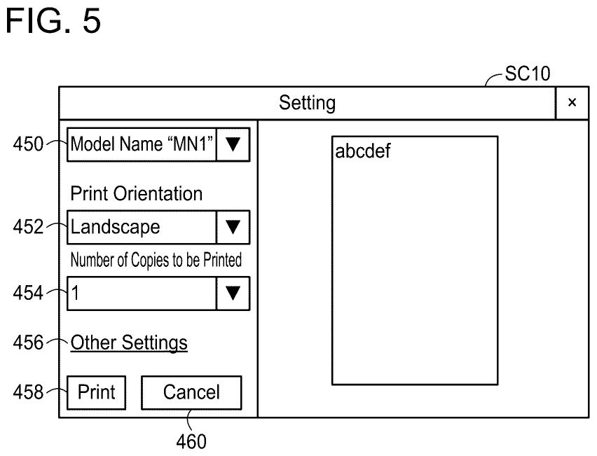

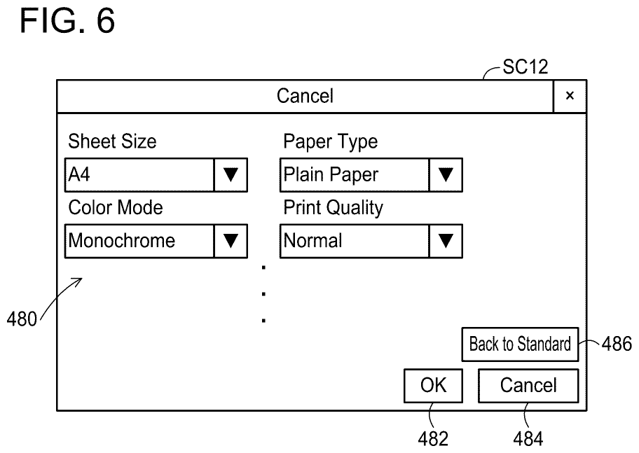

When the editing app 44 has acquired the capability information from the PSA 48 via the generic printing program 42 in T112, the editing app 44 displays a preview screen SC10 on the display unit 14 in T114. As illustrated in FIG. 5, the preview screen SC10 includes a printer selection region 450, a print orientation setting region 452, a number of printed copies setting region 454, an “Other Settings” object 456, a “Print” button 458, a “Cancel” button 460, and a preview image. In the printer selection region 450, the model name “MN1” of the printer 100 selected in T110 of FIG. 4 is displayed. The “Other Settings” object 456 is an object for displaying a print setting screen SC12 (see FIG. 6) for setting print setting other than the print orientation and the number of printed copies. The user performs a print operation in T116 of FIG. 4. The print operation is an operation on the “Print” button 458. Due to this, the editing app 44 supplies a print instruction including file information for specifying a file to be printed to the generic printing program 42 in T118.

When the generic printing program 42 acquires the print instruction from the editing app 44 in T118, the generic printing program 42 specifies a file corresponding to the file information in the print instruction. Subsequently, the generic printing program 42 converts the file into intermediate image data in T120, and supplies a second application activation instruction including the intermediate image data to the PSA 48 in T122.

When the PSA 48 has acquired the second application activation instruction from the generic printing program 42 in T122, the PSA 48 determines that the EULA flag is stored in the first predetermined region in T130 (YES to S10 of FIG. 2), and determines that the EULA flag is “ON” in T132 (YES to S12). In this case, the PSA 48 executes a print process corresponding to the print operation (S14) without displaying the EULA screen SC2. The print process is an example for the target process of FIG. 2. Specifically, in T140, the PSA 48 generates print data by converting the intermediate image data included in the second application activation instruction. The print data is data corresponding to the printer 100. Although this is an example, the print data is PDL data corresponding to a printer of the model name “MN1”. Subsequently, the PSA 48 sends the print data to the printer 100 in T142.

When the printer 100 has received the print data from the PC 10 in T142, the printer 100 executes printing using the print data in T144. As such, the printing using the editing app 44 is executed.

### (Case C; FIG. 5)

With reference to FIG. 4, Case C will be described. In Case C, the “Other Settings” object 456 on the preview screen SC10 (see FIG. 5) is selected. An initial state of Case C is the same as the initial state of Case B.

Firstly, processes the same as T110 to T114 of Case B are executed between the editing app 44, the PSA 48, the generic printing program 42, and the printer 100. In the present case, the user performs a print setting operation in T216. The print setting operation is an operation on the “Other Settings” object 456. Due to this, the editing app 44 supplies a print setting request to the generic printing program 42 in T218.

When the generic printing program 42 acquires the print setting request from the editing app 44 in T218, the generic printing program 42 supplies a third application activation instruction which is an instruction corresponding to displaying of the print setting screen SC12 (see FIG. 6) to the PSA 48 in T222.

When the PSA 48 acquires the third application activation instruction from the generic printing program 42 in T222, the PSA 48 determines that the EULA flag is stored in the first predetermined region in T230 (YES to S10 of FIG. 2), and determines that the EULA flag is “ON” in T232 (YES to S12). In this case, the PSA 48 executes a print setting screen display process which is a process corresponding to the print setting operation in T234 (S14), without displaying the EULA screen SC2. The print setting screen display process is an example for the target process of FIG. 2. Specifically, the PSA 48 displays the print setting screen SC12 on the display unit 14. As illustrated in FIG. 6, the print setting screen SC12 includes a setting region 480, an “OK” button 482, a “Cancel” button 484, and a “Back to Standard” object 486. The setting region 480 is a region for setting a paper size, a color mode, a paper type, and a print quality. The user performs a setting operation in T240 of FIG. 4. The setting operation includes an operation to change setting in the setting region 480 and an operation on the “OK” button 482. Due to this, the PSA 48 stores the print setting selected by the user in the memory 34, and supplies an instruction for displaying the preview screen SC10 to the editing app 44 in T242. Thereafter, by processes the same as T116 to T144 of Case B being executed, printing corresponding to the print setting selected by the user is executed.

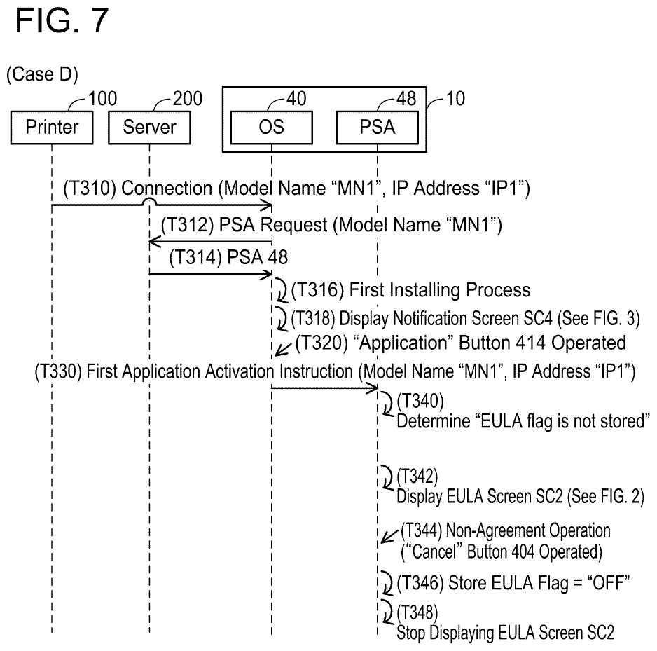

### (Case D; FIG. 7)

With reference to FIG. 7, Case D will be described. In Case D, a non-agreement operation is performed on the EULA screen SC2 displayed after the PSA 48 has been installed on the PC 10. An initial state of Case D is the same as the initial state of Case A of FIG. 3.

T310 to T342 are the same as T10 to T42 of FIG. 3. In the present case, the user performs the non-agreement operation in T344 (NO to S42 of FIG. 2). Due to this, the PSA 48 generates the EULA flag “OFF” in T346, and stores the generated EULA flag “OFF” in the first predetermined region (S50). Subsequently, in T348, the PSA 48 stops displaying the EULA screen SC2 without executing a process of displaying the application activation screen SC6 on the display unit 14 (S52).

### (Effects of Case A and Case D)

As mentioned above, when the PSA 48 acquires the first application activation instruction corresponding to the operation on the “Application” button 414 on the notification screen SC4 from the OS 40, the PSA 48 executes the image display process of FIG. 2. Accordingly, when the operation on the “Application” button 414 on the notification screen SC4 is received also, the EULA screen SC2 can be suitably displayed.

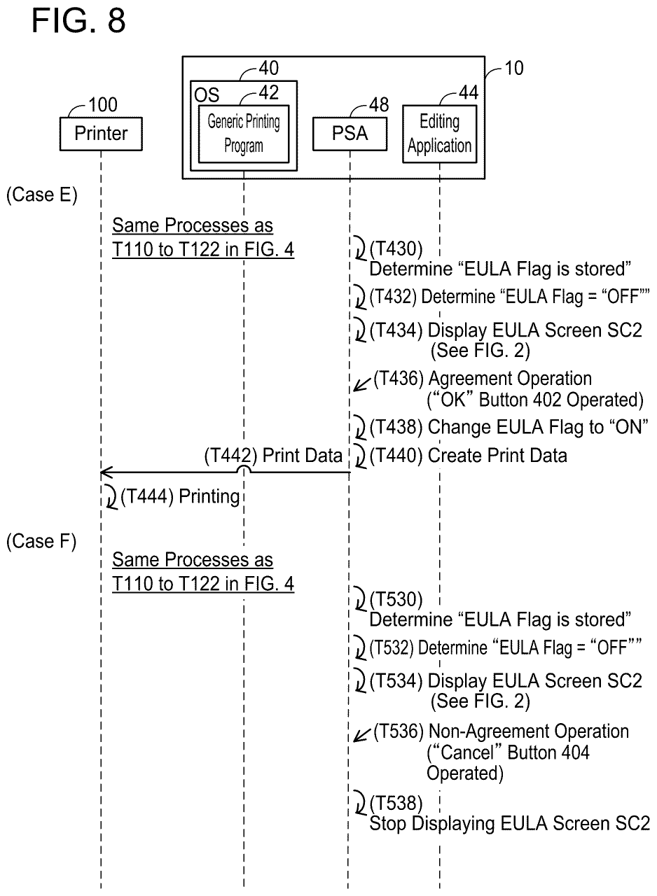

### (Case E; FIG. 8)

With reference to FIG. 8, Case E will be described. In Case E, printing using the editing app 44 is executed. An initial state of Case E is a state after Case D of FIG. 7. That is, the PSA 48 is installed on the PC 10, and also the EULA flag “OFF” is stored in the first predetermined region.

Firstly, the processes the same as T110 to T122 of FIG. 4 are executed between the editing app 44, the PSA 48, the generic printing program 42, and the printer 100. The PSA 48 determines that the EULA flag is stored in the first predetermined region in T430 (YES to S10 of FIG. 2), determines that the EULA flag is “OFF” in T432 (NO to S12), and displays the EULA screen SC2 (see FIG. 2) on the display unit 14 in T434 (S20). In T436, the user performs the agreement operation (YES to S22). Due to this, the PSA 48 changes the EULA flag in the first predetermined region from “OFF” to “ON” in T438 (S24). T440 to T444 are the same as T140 to T144 of FIG. 4. As such, when the user agrees on the EULA, the PSA 48 executes the print process corresponding to the print operation. Then, the printing using the editing app 44 is executed.

### (Case F; FIG. 8)

With reference to FIG. 8, Case F will be described. In Case F, printing using the editing app 44 is limited. An initial state of Case F is the same as the initial state of Case E.

Firstly, the processes the same as T110 to T122 of FIG. 4 are executed between the editing app 44, the PSA 48, the generic printing program 42, and the printer 100. T530 to T534 are the same as T430 to T434 of Case E. In T536, the user performs the non-agreement operation (NO to S22). In this case, the PSA 48 stops displaying the EULA screen SC2 without performing the print process which is a process corresponding to the print operation in T538. As such, when the user does not agree on the EULA, execution of the print process is limited. Due to this, printing using the editing app 44 is limited.

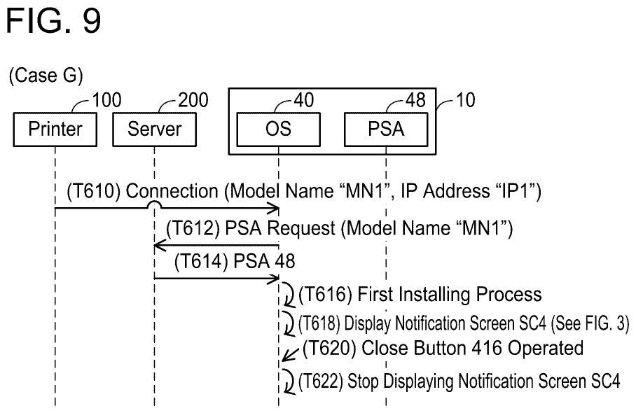

### (Case G; FIG. 9)

With reference to FIG. 9, Case G will be described. In Case G, the “Close” button 416 on the notification screen SC4 displayed after the PSA 48 has been installed on the PC 10 is selected. An initial state of Case G is the same as the initial state of Case A in FIG. 3.

T610 to T618 are the same as T10 to T18 of FIG. 3. In the present case, the user performs an operation on the “Close” button 416 on the notification screen SC4 in T620. Due to this, the OS 40 stops displaying the notification screen SC4 without supplying the first application activation instruction (see T30 of FIG. 3) to the PSA 48 in T622. Since the PSA 48 does not acquire the first application activation instruction from the OS 40, the PSA 48 does not execute the image display process of FIG. 2. Due to this, the EULA flag is not stored in the first predetermined region.

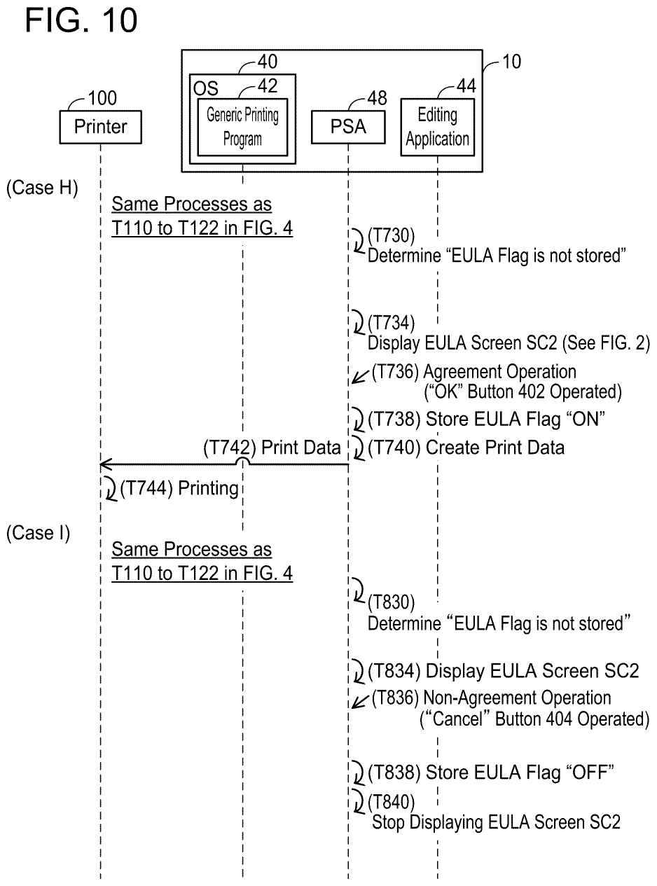

### (Case H; FIG. 10)

With reference to FIG. 10, Case H will be described. In Case H, printing using the editing app 44 is executed. An initial state of Case H is the state after Case G of FIG. 9. That is, although the PSA 48 has been installed on the PC 10, the EULA flag is not stored in the first predetermined region.

Firstly, the processes the same as T110 to T122 of FIG. 4 are executed between the editing app 44, the PSA 48, the generic printing program 42, and the printer 100. The PSA 48 determines that the EULA flag is not stored in the first predetermined region in T730 (NO to S10 of FIG. 2), and displays the EULA screen SC2 (see FIG. 2) on the display unit 14 in T734 (S40). The user performs the agreement operation in T736 (YES to S42). Due to this, the PSA 48 generates the EULA flag “ON”, and stores the generated EULA flag “ON” in the first predetermined region in T738 (S44). T740 to T744 are the same as T140 to T144 of FIG. 4. As such, when the user agrees on the EULA, the PSA 48 executes the print process which is a process corresponding to the print operation. Then, printing using the editing app 44 is executed.

### (Case I; FIG. 10)

With reference to FIG. 10, Case I will be described. In Case I, printing using the editing app 44 is limited. An initial state of Case I is the same as the initial state of Case H.

Firstly, the processes the same as T110 to T122 of FIG. 4 are executed between the editing app 44, the PSA 48, the generic printing program 42, and the printer 100. T830, T834 are respectively the same as T730, T734 of Case H. The user performs the non-agreement operation in T836 (NO to S42). Due to this, the PSA 48 generates the EULA flag “OFF” in T838, and stores the generated EULA flag “OFF” in the first predetermined region (S50). Also, the PSA 48 stops displaying of the EULA screen SC2 without executing the print process which is a process corresponding to the print operation in T840. As such, when the user does not agree on the EULA, execution of the print process is limited. Due to this, printing using the editing app 44 is limited.

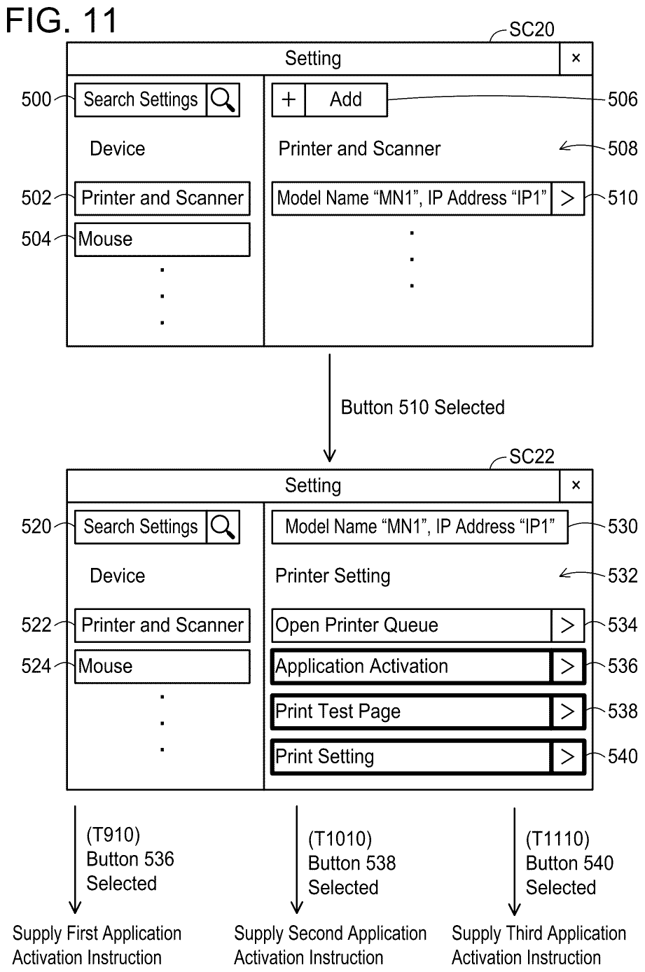

### (Device Setting Screen; FIG. 11)

With reference to FIG. 11, a first device setting screen SC20 and a second device setting screen SC22 that are displayed by the OS 40 will be described.

When the OS 40 receives a device setting operation, the OS 40 displays the first device setting screen SC20 on the display unit 14. The first device setting screen SC20 includes a search object 500, a “Printer and Scanner” button 502, a “Mouse” button 504, an “Add” button 506, and a “Printer and Scanner” region 508. The “Printer and Scanner” region 508 includes button(s) corresponding to a printer and a scanner that are registered on the PC 10. Under a state where the PSA 48 is installed on the PC 10, the “Printer and Scanner” region 508 includes a button 510 corresponding to the printer 100.

Here, when the OS 40 receives an operation on the “Add” button 506, the OS 40 executes a search process of searching printer(s) belonging to the LAN 4, and displays a printer list screen for selecting a printer to be connected to the PC 10 on the display unit 14. Then, in response to receiving a selection of a specific printer, the specific printer is connected to the PC 10. As such, the OS 40 detects that the specific printer is connected to the PC 10 through the communication I/F 20 which is a wired LAN I/F or a wireless LAN I/F.

When the OS 40 receives the operation on the button 510 on the first device setting screen SC20, the OS 40 displays the second device setting screen SC22 corresponding to the printer 100 on the display unit 14. The second device setting screen SC22 includes a search object 520, a “Printer and Scanner” button 522, a “Mouse” button 524, device information 530, and a printer setting region 532. The device information 530 includes information corresponding to a device selected on the first device setting screen SC20. The printer setting region 532 includes a “Printer Queue” button 534, an “Application Activation” button 536, a “Print Test Page” button 538, and a “Print Setting” button 540.

The “Application Activation” button 536 is a button for activating the PSA corresponding to the printer in selection. For example, when the OS 40 receives an operation on the “Application Activation” button 536 in T910 for example, the OS 40 supplies the first application activation instruction (see T30 of FIG. 2) including the model name “MN1” and the IP address “IP1” to the PSA 48. When the PSA 48 receives the first application activation instruction from the OS 40, the PSA 48 executes the image display process of FIG. 2. As such, also when the PSA 48 acquires the first application activation instruction corresponding to the operation on the “Application Activation” button 536 from the OS 40, the PSA 48 executes the image display process of FIG. 2. Accordingly, also when the operation on the “Application Activation” button 536 is received, the EULA screen SC2 can be suitably displayed.

The “Print Test Page” button 538 is a button for causing the printer in selection to print a test page. For example, a situation where the OS 40 receives an operation on the “Print Test Page” button 538 in T1010 will be assumed. In this case, the generic printing program 42 of the OS 40 converts a file corresponding to the test page into intermediate image data, and supplies the second application activation instruction (see T122 of FIG. 4) including the intermediate image data to the PSA 48. When the PSA 48 acquires the second application activation instruction from the OS 40, the PSA 48 executes the image display process of FIG. 2.

The “Print Setting” button 540 is a button for displaying the print setting screen SC12 (see FIG. 6) on the display unit 14. For example, a situation where the OS 40 receives an operation on the “Print Setting” button 540 in T1110 will be assumed. In this case, the generic printing program 42 of the OS 40 supplies the third application activation instruction (see T222 of FIG. 4) which is an instruction for displaying the print setting screen SC12 (see FIG. 6) to the PSA 48. When the PSA 48 receives a ninth application activation instruction from the OS 40, the PSA 48 executes the image display process of FIG. 2.

### (Effects by Present Embodiment)

According to the above configuration, when the second application activation instruction (or the third application activation instruction) is acquired from the OS 40 and also the EULA has not been agreed (NO to S10, NO to S12 of FIG. 2), the PC 10 displays the EULA screen SC2 on the display unit 14 in accordance with the PSA 48. Contrary to this, when the second application activation instruction (or the third application activation instruction) is acquired from the OS 40 and the EULA has been agreed (YES to S12), the EULA screen SC2 is not displayed. Accordingly, the EULA screen SC2 can be suitably displayed.

Also, when the PC 10 acquires the second application activation instruction (or the third application activation instruction), or the first application activation instruction from the OS 40 and also the end user license agreement has not been agreed (NO to S10, NO to S12 of FIG. 2), the PC 10 displays the EULA screen SC2 on the display unit 14 in accordance with the PSA 48. Contrary to this, when the second application activation instruction (or the third application activation instruction) or the first application activation instruction is acquired from the OS 40 and the end user license agreement has been agreed (YES to S12), the EULA screen SC2 is not displayed. Accordingly, the EULA screen SC2 can be suitably displayed.

### (Correspondence Relationships)

The PC 10 is an example for “terminal device”. The PSA 48 is an example for “support application program”. The operations of T116, T216 of FIGS. 4 and T1010, T1110 of FIG. 11 are examples for “printing-related operation”. The second application activation instruction in T122 of FIGS. 4 and T1010 of FIG. 11 and the third application activation instruction of T222 of FIG. 4, T1110 of FIG. 11 are examples for “first instruction”. The print process, the print setting screen display process are examples for “a process corresponding to the printing-related operation”.

In one aspect, the device setting operation is an example for “first predetermined operation”. T910 of FIG. 11 is an example for “second predetermined operation”. The first application activation instruction is an example for “second instruction”. The print application activation screen display process is an example for “process corresponding to the second predetermined operation”. T20 of FIG. 3 is an example for “third predetermined operation”. The first application activation instruction is an example for “third instruction”. The print application activation screen display process is an example for “process corresponding to the third predetermined operation”.

T434, T534 of FIGS. 8 and T734 of FIG. 10 are examples for a process realized by “in a case where a first instruction corresponding to a printing-related operation related to printing is acquired from the OS program and an end user license agreement related to the computer program has not been agreed, display, on a display of the terminal device, an end user license agreement screen”.

In another aspect, T116, T216 of FIGS. 4 and T1010, T1110 of FIG. 11 are examples for “first predetermined operation”. The second application activation instruction in T122 of FIG. 4, T1010 of FIG. 11 and the sixth application activation instruction in T222 of FIG. 4, T1110 of FIG. 11 are examples for “first instruction”. T20 of FIG. 3, T910 of FIG. 11 are examples for “second predetermined operation”. The first application activation instruction is an example for “second instruction”. The print process, the print setting screen display process are examples for “process corresponding to the first predetermined operation”. The print application activation screen display process is an example for “process corresponding to the second predetermined operation”.

T434, T534 of FIG. 8, T734 of FIG. 10 are examples for a process realized by “in a case where a first instruction corresponding to a printing-related operation related to printing is acquired from the OS program and an end user license agreement related to the computer program has not been agreed, display, on a display of the terminal device, an end user license agreement screen”. T42 of FIG. 3 is an example for a process realized by “in a case where a second instruction corresponding to a second predetermined operation different from the first predetermined operation is acquired from the OS program and the end user license agreement has not been agreed, display, on the display, the end user license agreement screen”.

Specific examples of the present disclosure have been described in detail, however, these are mere exemplary indications and thus do not limit the scope of the claims. The art described in the claims include modifications and variations of the specific examples presented above. Some of the modifications for the above embodiments will herein be listed as below.

### First Modification

The “terminal device” is not limited to a PC, but may be a mobile phone (e.g., smartphone), a PDA, for example.

### Second Modification

When the PSA 48 acquires the first application activation instruction from the OS 40, the PSA 48 may display the EULA screen SC2 on the display unit 14 without executing the image display process of FIG. 2.

### Third Modification

Although in the above embodiments the server 200 is a physical server, the server 200 is not limited to the physical one, but may be a virtual server, or a virtual machine on a cloud. That is, the vendor may not prepare hardware of the server 200 by themselves, but may use an environment prepared by an external cloud computing service. In this case, the vendor may realize the server 200 by preparing a program for the server 200 (i.e., software) and introducing the same in the above environment. In another modification, the server 200 may be arranged on the Internet 6 by a business entity different from the vendor.

### Fourth Modification

The “printing device” is not limited to a printer, but may be a device comprising a print engine, such as a multifunction machine, a copy machine.

### Fifth Modification

The “support application program” is not limited to a PSA, but may be a Hardware Support Application (HSA) or may be another Universal Windows Platform (UWP) application. Also, the “support application program” may be a virtual printer. The “support application program” may encompass programs of other various types which support or expand processes of a generic printing program.

### Sixth Modification

Although in each of the above-described embodiments the processes of FIGS. 2 to 11 are realized by software (e.g., programs 40, 42, 44, 46, 48), at least one of these processes may be realized by hardware such as a logic circuitry.

What is claimed is:

1. A non-transitory computer-readable recording medium storing a support application program for a terminal device,
wherein the support application program is a program for supporting a generic printing program implemented in an operating system (OS) program of the terminal device,
wherein the support application program, when executed by a processor of the terminal device, causes the terminal device to:
in a case where a first instruction corresponding to a printing-related operation related to printing is acquired from the OS program and an end user license agreement related to the support application program has not been agreed, display, on a display of the terminal device, an end user license agreement screen for receiving a selection operation of selecting whether to agree to the end user license agreement, wherein in a case where the first instruction is acquired from the OS program and the end user license agreement has been agreed, the end user license agreement screen is not displayed,
wherein in a case where an operation of not agreeing to the end user license agreement is received on the end user license agreement screen displayed in response to the first instruction being acquired from the OS program, execution of a process corresponding to the printing-related operation is limited.

2. The non-transitory computer-readable recording medium as in claim 1, wherein the printing-related operation is an operation to display a print setting screen on the display.

3. The non-transitory computer-readable recording medium as in claim 1, wherein the printing-related operation is an operation to send a print instruction to a printing device.

4. The non-transitory computer-readable recording medium as in claim 1, wherein the support application program, when executed by the processor, further causes the terminal device to:
in a case where a second instruction corresponding to a second predetermined operation on a device setting screen provided by the OS program is acquired from the OS program and the end user license agreement has not been agreed, display, on the display, the end user license agreement screen, wherein in a case where the second instruction is acquired from the OS program and the end user license agreement has been agreed, the end user license agreement screen is not displayed,
wherein in a case where an operation of not agreeing to the end user license agreement is received on the end user license agreement screen displayed in response to the second instruction being acquired from the OS program, execution of a process corresponding to the second predetermined operation is limited.

5. The non-transitory computer-readable recording medium as in claim 1, wherein in a case where the support application program is installed on the terminal device, a notification screen for notifying completion of installation is displayed on the display according to the OS program,
wherein the support application program, when executed by the processor, further causes the terminal device to:
in a case where a third instruction corresponding to a third predetermined operation on the notification screen is acquired from the OS program and the end user license agreement has not been agreed, display, on the display, the end user license agreement screen,
wherein in a case where an operation of not agreeing to the end user license agreement is received on the end user license agreement screen displayed in response to the third instruction being acquired from the OS program, execution of a process corresponding to the third predetermined operation is limited.

6. A non-transitory computer-readable recording medium storing a support application program for a terminal device,
wherein the support application program is a program for supporting a generic printing program implemented in an operating system (OS) program of the terminal device,
wherein the support application program, when executed by a processor of the terminal device, causes the terminal device to:
in a case where a first instruction corresponding to a first predetermined operation is acquired from the OS program and an end user license agreement related to the support application program has not been agreed, display, on a display of the terminal device, an end user license agreement screen for receiving a selection operation of selecting whether to agree to the end user license agreement, wherein in a case where the first instruction is acquired from the OS program and the end user license agreement has been agreed, the end user license agreement screen is not displayed; and
in a case where a second instruction corresponding to a second predetermined operation different from the first predetermined operation is acquired from the OS program and the end user license agreement has not been agreed, display, on the display, the end user license agreement screen, wherein in a case where the second instruction is acquired from the OS program and the end user license agreement has been agreed, the end user license agreement screen is not displayed,
wherein in a case where an operation of not agreeing to the end user license agreement is received on the end user license agreement screen displayed after the first instruction has been acquired from the OS program, execution of a process corresponding to the first predetermined operation is limited, and
in a case where an operation of not agreeing to the end user license agreement is received on the end user license agreement screen displayed after the second instruction has been acquired from the OS program, execution of a process corresponding to the second predetermined operation is limited.

7. The non-transitory computer-readable recording medium as in claim 6, wherein the second predetermined operation is an operation on a device setting screen provided by the OS program.

8. The non-transitory computer-readable recording medium as in claim 7, wherein the first predetermined operation is an operation to display a print setting screen on the display.

9. The non-transitory computer-readable recording medium as in claim 7, wherein the first predetermined operation is an operation to send a print instruction to a printing device.

10. A method for controlling a terminal device according to a support application program;
wherein the support application program is a program for supporting a generic printing program implemented in an operating system (OS) program of the terminal device,
wherein the method comprises:
in a case where a first instruction corresponding to a printing-related operation related to printing is acquired from the OS program in accordance with the support application program and an end user license agreement related to the support application program has not been agreed, displaying, on a display of the terminal device, an end user license agreement screen for receiving a selection operation of selecting whether to agree to the end user license agreement, wherein in a case where the first instruction is acquired from the OS program and the end user license agreement has been agreed, the end user license agreement screen is not displayed,
wherein in a case where an operation of not agreeing to the end user license agreement is received on the end user license agreement screen displayed in response to the first instruction being acquired from the OS program, execution of a process corresponding to the printing-related operation is limited.

11. The method as in claim 10, wherein the printing-related operation is an operation to display a print setting screen on the display.

12. The method as in claim 10, wherein the printing-related operation is an operation to send a print instruction to a printing device.

13. The method as in claim 10, further comprising:
in a case where a second instruction corresponding to a second predetermined operation on a device setting screen provided by the OS program is acquired from the OS program and the end user license agreement has not been agreed, displaying, on the display, the end user license agreement screen, wherein in a case where the second instruction is acquired from the OS program and the end user license agreement has been agreed, the end user license agreement screen is not displayed,
wherein in a case where an operation of not agreeing to the end user license agreement is received on the end user license agreement screen displayed in response to the second instruction being acquired from the OS program, execution of a process corresponding to the second predetermined operation is limited.

14. The method as in claim 10, wherein in a case where the support application program is installed on the terminal device, a notification screen for notifying completion of installation is displayed on the display according to the OS program,
wherein the method further comprises:
in a case where a third instruction corresponding to a third predetermined operation on the notification screen is acquired from the OS program and the end user license agreement has not been agreed, displaying, on the display, the end user license agreement screen,
wherein in a case where an operation of not agreeing to the end user license agreement is received on the end user license agreement screen displayed in response to the third instruction being acquired from the OS program, execution of a process corresponding to the third predetermined operation is limited.
